(19) United States
(12) Patent Application Publication
(10) Pub. No.: US 2006/0123959 A1
(43) Pub. Date: Jun. 15, 2006

(54) Cutter blade for cast saw

(75) Inventor: Donald Rocco Bocast, Colorado Sprins, CO (US)

Correspondence Address: LAW OFFICE OF DALE B. HALLING, LLC, 655 SOUTHPOINTE COURT, SUITE 100, COLORADO SPRINGS, CO, 80906, US

(73) Assignee: ELITE MEDICAL EQUIPMENT, LLC

(21) Appl. No.: 11/270,846

(22) Filed: Nov. 9, 2005

Related U.S. Application Data
(60) Provisional application No. 60/629,260, filed on Nov. 19, 2004.

(51) Int. Cl. B26D 1/00

(52) U.S. Cl. 83/13

(57) ABSTRACT

A cast saw blade includes a hardened metal blank having a hub section and a cutting edge with an integral cutting depth guide. The cutting depth guide includes one or more apertures near the cutting edge. The blade includes a rounded sector blade cutting edge to minimize the amount of materials required. The cutting edge is only partially toothed, and partially smooth and dull. The blade is attached to a saw via a hub section that includes seven mounting holes around a central arbor, so that the blade is compatible with all prior cast saw hubs. The arrangement of the teeth makes a directional blade. The blade is easily reversed to cut in the opposite direction. Both sides of the blade are marked to indicate the cutting direction. The blade is formed through a chemical etching process to eliminate annealing and tempering after machining.

### PRIORITY DATA

This application is a claims priority from U.S. patent application Ser. No. 60/629,260 filed on Nov. 19, 2004, entitled “IMPROVED CUTTER BLADE FOR CAST SAW” and is hereby incorporated by reference.

### FIELD OF THE INVENTION

This invention relates generally to the field of saw blades, and more specifically to saw blades for oscillating saws, such as cast and autopsy saws.

### BACKGROUND OF THE INVENTION

Removal of casts protecting an injured limb is routine in all clinics. However, an autopsy saw is cumbersome to handle and operate, and cutting a patient's skin is very likely if the ‘cast technician’ is not properly trained to avoid going too deep through the cast.

The blades used on prior art cast saws are either round or like a pie segment with saw teeth covering the entire available arc. The pie segment saws have sharp corners and care needs to be taken in handling to avoid cutting the patient.

The prior art blade manufacturers have adapted some blade-shaping techniques found on slitting saws used in metal work. The blade of a slitting saw is thickest at the teeth. Directly behind the teeth, toward the center of the blade, is the web. The web is reduced in thickness to minimize dragging on the work. Dragging is simply unwanted extra friction and heat. Typically, prior art blades are milled to reduce the thickness of the blade material from about 0.032 inches down to 0.026 inches. However, removing 0.003 inches from each side of the side of the blade is an expensive and tricky milling operation. To accomplish the machining, the material for the blade is selected on the basis of machinability with the capability of being heat treated to the desired hardness for reasonable life. Attaining a high hardness in the finished product is difficult. What is needed is a way to reduce the cost and difficulty of producing the web.

Prior art blades have teeth along the entire cutting edge. However, only a very small part of a cast saw blade is used to cut. These extra teeth serve only as a hazard to the patient.

Prior art blades have teeth that are triangular to cut in both directions equally well. It's a compromise, but blades are difficult to make and expensive to replace.

In clinical use, prior art blades wear out quickly. Typical blade life is 2 to 4 weeks.

Thus, what is needed is a saw blade that cuts better and lasts longer than the prior art blades, is suitable for right- or left-hand use, and is much cheaper to manufacture.

It is intended that any other advantages and objects of the present invention that become apparent or obvious from the detailed description or illustrations contained herein are within the scope of the present invention.

### SUMMARY OF THE INVENTION

A cast saw blade includes a hardened metal blank having a hub section and a cutting edge and a cutting depth guide formed into the blade near the cutting edge. The cutting edge is only partially toothed, while the remainder is smooth and dull. The blade does not need to have a circumferential cutting edge, but has a sector blade cutting edge instead. The sector blade is only partially toothed and has rounded corners to further improve patient safety. The hub section includes a seven mounting holes arrangement around a central arbor. This arrangement is compatible with all prior cast saw hubs.

The cutting edge includes unidirectional teeth and the blade is marked to indicate the cutting direction. The blade is reversible to suit different users. Because the blade is formed through photo- or electro-chemical etching, the user can start with a very hard steel. The chemical machining process does not affect the steel's properties, thus the finished blades require no annealing or tempering after they are processed.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### BRIEF DESCRIPTION OF THE DRAWINGS

FIG. 1. is a perspective view of a cast saw blade, according to the present invention;

FIG. 2. is a perspective view of a cast saw blade, according to the present invention;

FIG. 3 is a side view of a cast saw blade used to gauge cutting depth, according to the present invention; and

FIG. 4 is a perspective view of a cast saw blade with a cast saw, according to the present invention.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DETAILED DESCRIPTION OF THE INVENTION

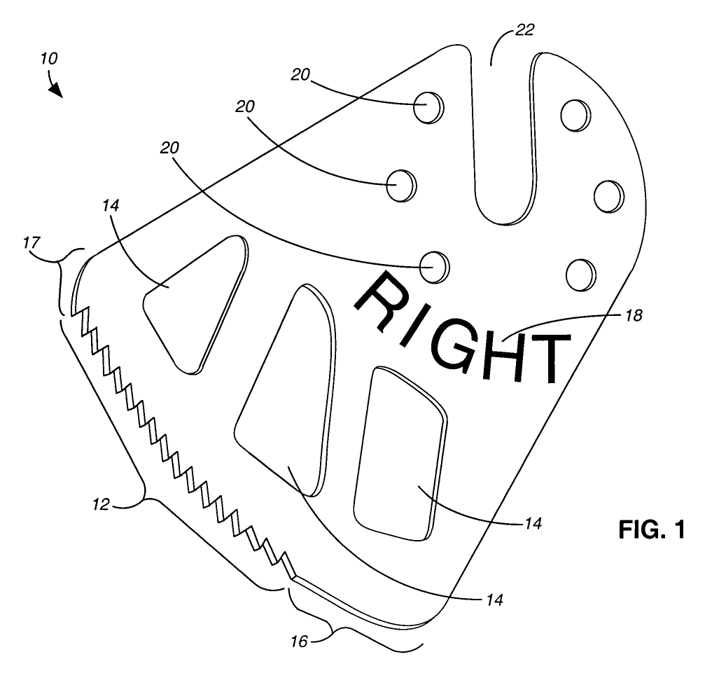

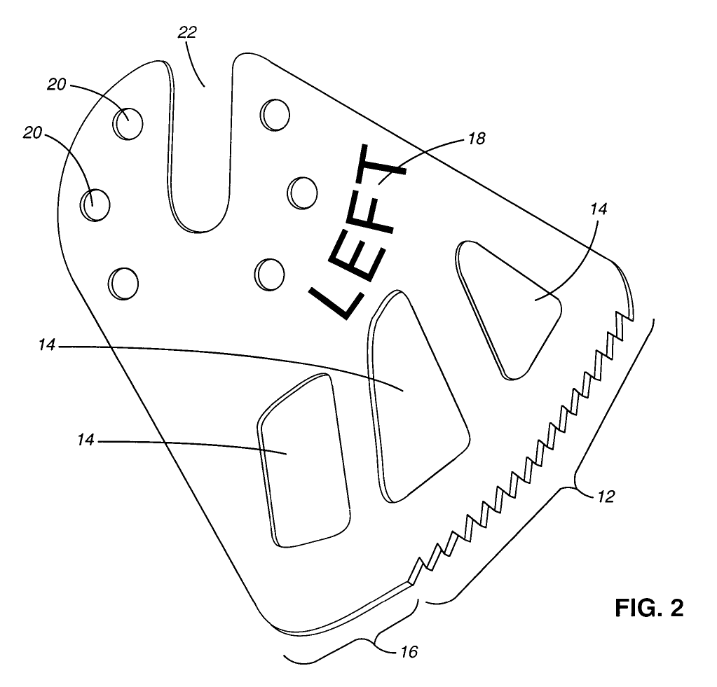

Referring now to the drawings, the attached figures illustrate a saw blade for a cast saw. FIGS. 1 and 2 show right and left sides of the cast saw blade 10. The cast saw blade 10 is made from a hardened metal blank, such as scalpel steel. A number of apertures 14 are formed into the web near the cutting edge 12. The apertures 14 in the web also solve a couple of problems found in the prior art. First, the apertures 14 create a cutting depth guide 16, and permit a user, such as a medical technician, to accurately determine how deep he has cut into a cast, and therefore, how close the blade is to the patient's skin. Thus, the ‘spokes’ in the web need not be of the typical radial design, but can provide a practical aid for the technician. Oscillating saws, such as cast saws, rotate back and forth only a very small amount and at a very high frequency, thus are not prone to causing serious injury. However, any contact with a patient's skin can be disconcerting. It is best to avoid the issue if possible. Second, the large apertures 14 in the web act to reduce the amount of material that drags against the cast as it is cut. Less drag means less heat. Heat is the enemy of hardened steel. The large apertures 14 in the web also allow for improved blade cooling.

Prior art blades have teeth along the entire cutting edge. However, only certain parts of a cast saw blade are used to cut. These extra teeth serve only as a hazard to the patient. Thus, it makes no sense to have teeth along the entire cutting edge. One solution is to replace part of the toothed cutting edge 12 with two smooth, dull edges, 16 and 17, that aid in preventing injury to the patient's skin.

FIGS. 1 and 2 show that the cutting edge 12 is only partially toothed and the two remaining parts of the cutting edge 12 are smooth and dull, 16 and 17. The comers are well-rounded. The blade 10 shown is a sector blade, having a limited cutting edge 12, 16 and 17, instead of having a cutting edge around its entire circumference.

Prior art blades have teeth that cut in both directions equally well. It is a compromise, but blades are difficult to make and expensive to replace. A compromise blade can be cheaper, but an inexpensive blade with a short life span is not a satisfactory solution. However, there is a solution to both of these problems.

First, a more efficient blade design has unidirectional teeth, i.e., a “normal” saw tooth shape. The teeth are asymmetrical, when viewed in profile. Such a blade cuts effectively in only one direction. A unidirectional blade requires that the blade be mounted differently for right-handed and left-handed cast technicians. However, this is easily accomplished.

FIGS. 1 and 2 show that cutting edges 12 with a preferred cutting direction 18. The teeth on the blade 10 are formed to cut best in one direction only. The preferred cutting direction 18 is marked on the blade 10 so that it is visible to the user. FIG. 1 shows the blade 10 mounted in a position for right hand use. FIG. 2 shows the opposite side of the blade 10, which is appropriate for left hand use. The blade 10 is easily reversed to suit different users. Further, some left handed users may prefer to hold the saw with their right hand or in another orientation that defies the indicated cutting direction 24. Either way, the user can find an effective orientation.

To eliminate confusion and prevent errors, the blade 10 is clearly marked LEFT on one side and RIGHT on the other. The cast saw blade 10 includes a hub section having seven mounting holes 20 around a central arbor 22. This design is compatible with all prior cast saw hubs. No special, dedicated equipment or replacement hub is necessary. The blade 10 can quickly be changed from left to right to suit any user.

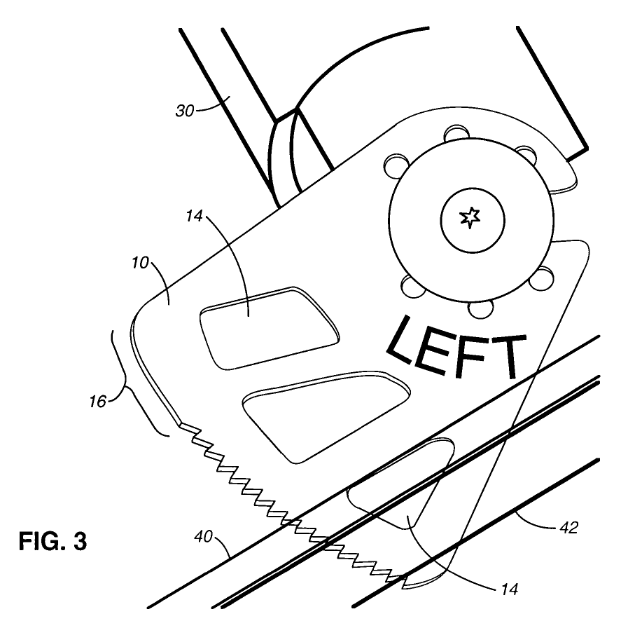

FIG. 3 shows the blade 10 used to gauge the depth of the cut. The blade is mounted to a cast saw 30, which is in the background. The orientation of the apertures 14, and the spokes that are created between the apertures 14 provide a guide that a technician can use to monitor cutting depth. Notice that one side of the blade 10 is extending down through the cast 40 and into the padding 42. In this orientation, the edges of the apertures 14 are approximately parallel to the surface of the cast 40. By knowing the approximate depth of a typical cast, the technician can confidently cut through the cast 40 without bumping into the patient's skin. Further, the apertures 14 can be marked or standardized so that the cutting depth is uniform for all similar blades 10. In this example, the technician can know that he has cut deep enough when the top edge of the lower aperture 14 is even with the cast 40.

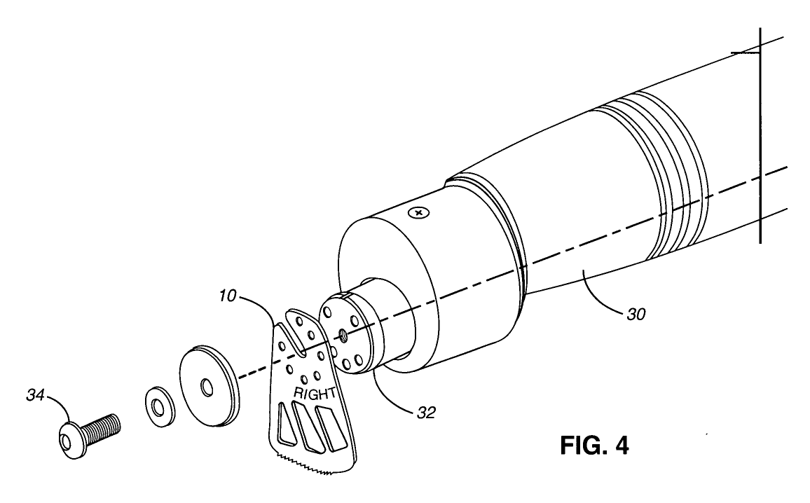

FIG. 4 shows a cast saw blade 10 as it mounts to a cast saw 30. Notice that the saw's hub 32 has only five pins. This pin arrangement mates perfectly with the seven-hole arrangement of the blade 10. The two unused holes are used when the blade 10 is inverted, such as from right to left. A single bolt 34 extends through the blade's arbor 22 and into the hub 32. The bolt 34 does not need to be completely removed for the blade 10 to be replaced or inverted. The bolt 32 needs to be loosened only enough so that the seven holes 20 can clear the hub's 32 pins.

Prior art cast saw blades are made from ordinary or tempered steel. However, during the machining process, the blades are heated significantly as they are cut and ground. The high heat affects the hardness of the steel blade. Thus, these blades need to be annealed and tempered after production before they can be used. While these blades look good and cut well, they have a few drawbacks.

In clinical use, prior art blades wear out quickly. Typical blade life is 2 to 4 weeks. An expensive blade that wears out quickly is not a good solution. Photo- and electro-chemical machining provides a solution. An unexpected result occurred when chemical etching was tried for shaping blades, resulting in a superior blade.

Photochemical machining uses image transfer technology to create a precise, acid-resistant image on a flat piece of metal. Chemicals are applied to etch away the uncoated metal around the image. The resulting part is not as precisely shaped as through conventional machining, but the part has not been stressed. Its material properties are not affected in any way. Electrochemical machining is a way of machining metal via electrolysis. The disclosed cast saw blade 10 is formed through photo- or electro-chemical etching. Laser or water jet cutting could also be used to obtain this configuration. Laser or jet cutting is a serial process where photo-chemical etching is a step and print process producing lower per piece cost. Chemical etching offers several advantages.

First, the blade material is not affected in any way, thus no annealing and tempering is required. If the user selects a particular type of hardened steel for etching, at the end of the etching process, the steel is every bit as hard as when it started. Second, the resulting blade 10 offers greatly improved life. Such blades 10 can last four months or longer. This improved blade life is partly due to the ability to start with very hard steel and due to an unexpected result of photo- and electrochemical machining. It was found that chemical machining processes do not create squared edges and comers like traditional machining. Instead, the process of etching, like erosion, creates a tapered edge.

Chemically etching hardened steel, such as scalpel steel, produced the proper unidirectional saw tooth shape, when viewed from the side. However, when viewed edge on, the leading and trailing edges of the teeth were found to be cusped. The traditional flat-sided teeth with squared, sharp comers were not there. The cusped cutting edges of the blade resemble shark teeth. Blades produced in this manner cut aggressively and extended the service life of the blade to more than four months. Additionally, from start to finish, blades produced via chemical etching cost about one sixth of traditional machining, annealing and tempering.

While the invention has been described with preferred specific embodiments thereof, it will be understood that this description is intended to illustrate and not to limit the scope of the invention, which is defined by the following claims.

I claim:

1. A cast saw blade comprising:
a hardened metal blank, that further comprises
a chemical etching-defined cutting edge.

2. The cast saw blade of claim 1, where the cutting edge further comprises a plurality of unidirectional teeth.

3. The cast saw blade of claim 2, where the cutting edge further comprises a partially-toothed cutting edge.

4. The cast saw blade of claim 1, where the blade further comprises seven mounting holes around a central arbor.

5. A cast saw blade comprising:
a hardened metal blank, that further comprises
a plurality of unidirectional teeth.

6. The cast saw blade of claim 5, where the blade further comprises one or more apertures in a web section of the blade.

7. The cast saw blade of claim 6, where the apertures further comprise a cutting depth guide.

8. A cast saw system comprising:
a cast saw;
a blade attached to the cast saw, wherein the blade has a hardened metal blank, that further comprises a partially-toothed cutting edge.

9. The cast saw blade of claim 8, where the blade further comprises a partially untoothed cutting edge.

10. The cast saw blade of claim 9, where the untoothed edge is smooth and dull.

11. The cast saw blade of claim 8, where the cutting edge further comprises unidirectional teeth.

12. The cast saw blade of claim 11, where the blade is reversible and directional.

13. The cast saw blade of claim 8, where the blank further comprises a sector blade design.

14. A method of manufacturing a cast saw blade comprising the steps of:
(a) selecting a blank of high hardness metal;
(b) etching a saw blade shape against the blank; and
(c) removing material from around the blade shape.

15. The method of manufacturing a cast saw blade of claim 14, where the blank of metal is scalpel steel

16. The method of manufacturing a cast saw blade of claim 14, where step (b) further comprises the step of:
(b1) printing an acid-resistant image of a saw blade onto a portion of the blank.

17. The method of manufacturing a cast saw blade of claim 14, where step (c) further comprises the step of:
(c1) performing photochemical machining on the blank.

18. The method of manufacturing a cast saw blade of claim 16, where step (c) further comprises the step of:
(c1) applying an acid solution to the blank; and
(c2) dissolving the portion of the blank that is not covered by the acid-resistant image.

19. The method of manufacturing a cast saw blade of claim 14, where step (b) further comprises the step of:
(b1) preparing an inverse image of the saw blade on a cathode;

20. The method of manufacturing a cast saw blade of claim 14, where step (c) further comprises the step of:
(c1) performing electrochemical machining on the blank.

21. The method of manufacturing a cast saw blade of claim 19, where step (c) further comprises the step of:
(c1) establishing the blank as an anode;
(c2) orienting the inverse image cathode parallel to the blank anode;
(c3) establishing a constant close distance between anode and cathode;
(c4) passing a high amperage, low voltage direct current between anode and cathode;
(c5) maintaining the constant close distance between anode and cathode; and
(c6) ceasing the direct current when the blank anode is fully electrochemically machined into a saw blade.
